(19) United States
(12) Patent Application Publication
(10) Pub. No.: US 2009/0089130 A1
(43) Pub. Date: Apr. 2, 2009

(54) INTEGRATION OF FINANCIAL MODELS INTO WORKFLOW SOFTWARE TO ENABLE ACTIVITY BASED COSTING

(75) Inventor: Wayne Malkin, Edmonton (CA)

Correspondence Address: LAW OFFICE OF DONALD L. WENSKAY, P.O. Box 7206, Rancho Santa Fe, CA, 92067, US

(73) Assignee: International Business Machines Corporation, Armonk, NY (US)

(21) Appl. No.: 11/957,631

(22) Filed: Dec. 17, 2007

(30) Foreign Application Priority Data
Oct. 1, 2007 (DE) 10 2007 047 075.6

(51) Int. Cl. G06Q 10/00

(52) U.S. Cl. 705/8; 705/7

(57) ABSTRACT

A system and method for integrating financial models into workflow software to enable Activity Based Costing. In one embodiment of the invention, a workflow modeling system comprises a workflow modeling tool including a workflow design tool and an activity-based cost design tool. A unified workflow and financial model is generated by the workflow modeling tool and a workflow execution module executes the unified workflow and financial model. A workflow monitoring and controlling application receives workflow and cost data from the workflow execution module and a financial monitoring and controlling application receives cost data from the workflow execution module. A workflow change module communicates workflow changes to the unified workflow and financial model, wherein the unified workflow and financial model is automatically modified in response to the workflow changes.

### FIELD OF INVENTION

The present invention generally relates to process analysis systems, and particularly to systems and methods for integrating financial models into workflow software.

### BACKGROUND

In a business organization, Activity Based Costing (ABC) is a method of assigning the organization's resource costs through activities to the products and services provided to its customers. ABC is generally used as a tool for understanding product and customer cost and profitability. As such, ABC has predominately been used to support strategic decisions such as pricing, outsourcing, identification and measurement of process improvement initiatives.

ABC was developed as an approach to solve the problems of traditional cost management systems. These traditional costing systems are often unable to determine accurately the actual costs of production and related services. Consequently managers were making decisions based on inaccurate data especially where there are multiple products. Instead of using broad arbitrary percentages to allocate costs, ABC seeks to identify cause and effect relationships to objectively assign costs. Once costs of the activities have been identified, the cost of each activity is attributed to each product to the extent that the product uses the activity. ABC often identifies areas of high costs per unit and so directs attention to finding ways to reduce the costs or to charge more for costly products.

ABC is generally viewed as a desirable management tool to make informed decisions about business optimization, value of individual products, and the cost of servicing specific customers. However the collection of data and continual validation of the assumptions surrounding ABC can make the cost of ABC itself prohibitive.

Business Process Management (BPM) is an emerging field of knowledge and research at the intersection between management and information technology, encompassing methods, techniques and tools to design, enact, control and analyze operation business processes involving humans, organizations, applications, documents and other sources of information. BPM covers activities performed by organizations to manage and, if necessary, to improve their business processes. While such a goal is hardly new, software tools called business process management systems have made such activities faster and more cost effective. BPM systems monitor the execution of the business processes so that managers can analyze and change processes in response to data, rather than just a hunch.

In brief, BPM, or more simply, electronically enabled workflow, is used to model, automate, and optimize the flow of information and work in many key business processes. The activities analyzed in a typical workflow using BPM, such as the approval of a lending application, may be the same activities that are analyzed to perform ABC. However, BPM and ABC are usually performed independently. As a result there may be some duplication of effort when ABC and BPM are performed on the same subject matter. Further, because ABC and BPM are conducted separately, information and tools developed using BPM may not be available to the ABC process and information tools developed using ABC may not be available to the BPM process.

Another problem with ABC is the maintenance of the financial model when processes undergo process re-engineering. This is frequently a breaking point for ABC, as the assumptions underlying ABC must be revisited in detail when the process changes. Prevailing opinion has been that process re-engineering is costly and rarely performed, and that, once automated, business processes remain stable. However advances in BPM tools, including process simulation and analysis, have placed process re-engineering capabilities in the hands of the business users, resulting in far more frequent process changes.

Another consequence of the advances in BPM tools is that it has become far easier to design, deploy, and maintain a large number of automated business processes. Consequently, the number of activities that are automated and tracked is growing, and is no longer confined to a small number of the highest value business processes in an organization.

Accordingly, there is a need for systems and methods that improve on existing ABC and BPM systems and to reduce the duplication of effort when both techniques are employed on the same subject matter. Also, there is a need for ways in which information and tools gained from ABC may be utilized in BPM processes. In addition, there is a need for ways in which information and tools gained from BPM may be utilized in ABC processes. Further there is a need to provide a mechanism for maintaining the financial model in ABC when processes undergo routine or even large scale re-engineering.

### SUMMARY OF THE INVENTION

To overcome the limitations in the prior art briefly described above, the present invention provides a method, computer program product, and system for integration of financial models into workflow software to enable Activity Based Costing (ABC).

In one embodiment of the present invention a method for analyzing a workflow comprises: designing a workflow; designing activity-based cost distributions; generating a unified workflow and financial model using the workflow and the activity-based cost distributions; executing the unified workflow and financial model to generate workflow and cost data; processing the workflow and cost data in a workflow monitoring and controlling application; and processing the cost data in a financial monitoring and controlling application.

In another embodiment of the present invention, a method of integrating a financial model into a workflow model comprises: using a single tool for designing a workflow and for designing activity-based cost distributions; using the workflow and the activity-based cost distributions to generate a unified workflow and financial model; using the unified workflow and financial model to generate workflow and cost data; and processing the workflow and cost data in a workflow monitoring and controlling application.

In an additional embodiment of the present invention a workflow modeling system comprises: workflow modeling tool including a workflow design tool and an activity-based cost design tool; a unified workflow and financial model generated by the workflow modeling tool; a workflow execution module executing the unified workflow and financial model; workflow monitoring and controlling application receiving workflow and cost data from the workflow execution module; and financial monitoring and controlling application receiving cost data from the workflow execution module.

In another embodiment of the present invention, a computer program product comprises a computer usable medium having a computer readable program, wherein the computer readable program when executed on a computer causes the computer to: design a workflow; design activity-based cost distributions; generate a unified workflow and financial model using the workflow and the activity-based cost distributions; execute the unified workflow and financial model to generate workflow and cost data; process the workflow and cost data in a workflow monitoring and controlling application; and process the cost data in a financial monitoring and controlling application.

Various advantages and features of novelty, which characterize the present invention, are pointed out with particularity in the claims annexed hereto and form a part hereof. However, for a better understanding of the invention and its advantages, reference should be made to the accompanying descriptive matter together with the corresponding drawings which form a further part hereof, in which there are described and illustrated specific examples in accordance with the present invention.

### BRIEF DESCRIPTION OF THE DRAWINGS

The present invention is described in conjunction with the appended drawings, where like reference numbers denote the same element throughout the set of drawings:

FIG. 1 shows a conceptual block diagram of a system for integrating financial models into workflow software in accordance with an embodiment of the present invention;

FIG. 2 shows a conceptual of a system for integrating financial models into workflow software in accordance with an embodiment of the present invention; and

FIG. 3 shows a high level block diagram of an information processing system useful for implementing one embodiment of the present invention.

### DETAILED DESCRIPTION OF THE INVENTION

The present invention overcomes the problems associated with the prior art by teaching a system, computer program product, and method for integrating financial models into workflow software to enable Activity Based Costing (ABC). The invention involves the introduction of financial tools into a Business Process Management (BPM) system. As a result, the model of the workflow also models the cost drivers of the system. In addition, process analysis tools can be applied to generate ABC financial outputs. In the prior art, ABC and BPM were performed separately and resulted in some duplication of processes as information and tools from ABC were not available to BPM and information and tools from BPM were not available to ABC.

Workflows, such as BPM, include a number of steps and actions that are to be taken at each step. ABC also involves the reduction of a complex task or process into financially relevant steps such that the cost drivers for the process can be determined, and costs can be attributed to various products, groups, customers, and so on. In accordance with embodiments of the invention, by introducing a financial aspect to workflow modeling, steps in the workflow can be related to cost drivers. Cost drivers that do not relate to a step in the workflow can be modeled within the system as finance-only steps. These steps would perform no work, but would accumulate costing information for later analysis.

By using the teachings of the invention, steps that involve a person performing an action can be timed such that the labor hours of performing the step can be more accurately modeled, and variations in the labor hours (and thus cost) can be attributed accurately to the cause of that variation. For example, an analysis could be performed to determine which customers require the greatest number of labor hours of post-sales support. Costs associated with initiating support incidents with other agencies could also be tracked and attributed to the customer and product that drove that activity.

The financial model of work may operate in parallel and, in many cases, would simply follow the physical movement of the work item. Thus it would be a simple matter to maintain the financial model when processes undergo process re-engineering. This is frequently a breaking point for ABC, as the assumptions underlying ABC must be revisited in detail when the process changes. By modeling ABC within the workflow system in accordance with the invention, process changes would be immediately reflected in the costing reports.

Also, the present invention enables the user to define and maintain a global cost model, and to distribute those costs over a large number of deployed workflows. Another feature of the present invention is the ability to integrate cost and resource consumption data with the workflow, so that a business user who is modifying the workflow will automatically be updating the cost data as well. Furthermore, the invention provides the ability to roll up actual costs from a large number of workflows and review that at a global level. This could drive changes to the global cost model described above. Changes to the global cost model, such as the estimated cost of a given resource, would then automatically be reflected in the cost data accumulated for all workflows that consume that resource.

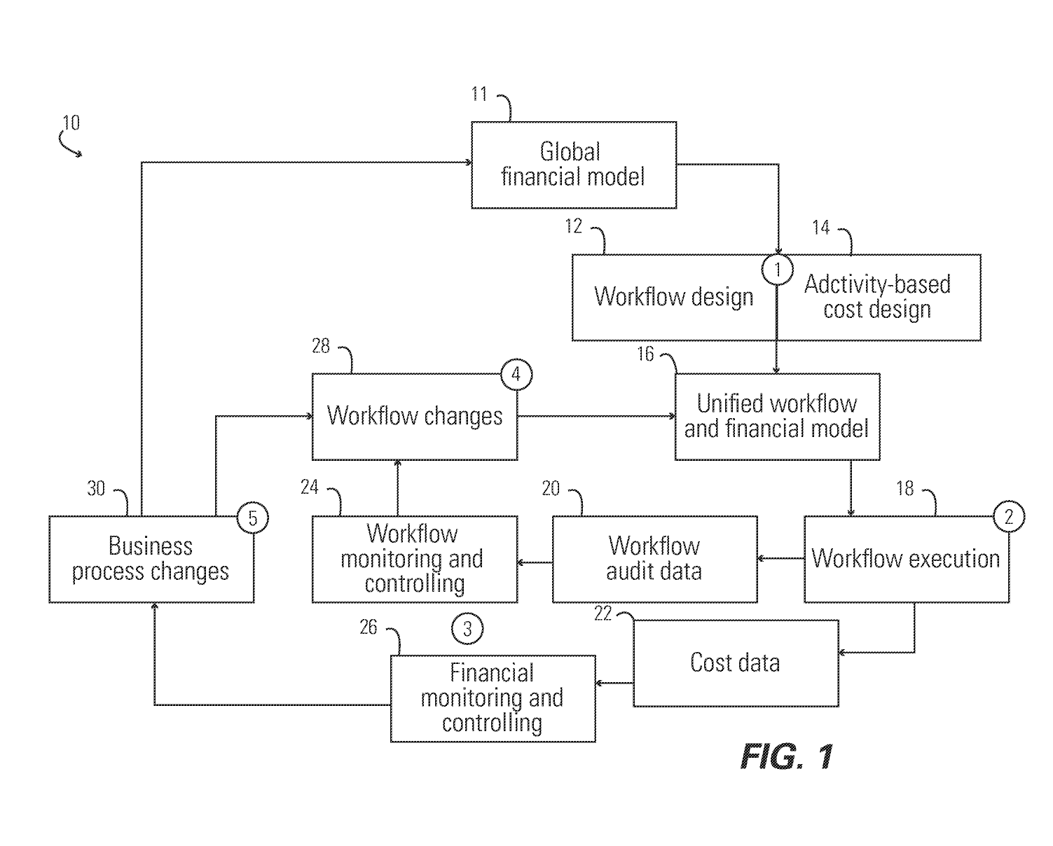

Referring now to FIG. 1, there is shown a conceptual block diagram of a system 10 for integrating financial models into workflow software in accordance with an embodiment of the present invention. FIG. 1 also illustrates five steps of a process in accordance with an embodiment of the invention. An initial global financial model 11 is developed and is used as an input to the ABC component of workflows designed and deployed on the system 10. These workflows execute and accumulate audit data as well as detailed cost data.

In more detail, in step 1, workflow design 12 and activity-based cost design 14 are performed. The workflow design and activity-based cost distributions may be designed independently. Alternatively, the two are built together in a single tool. That is, in some embodiments of the invention, workflow modeling tools also include cost modeling tools. Costs can be assigned to work steps based on fixed cost, calculated from data in the workflow, based on durations, and so on. Costs can also be allocated on the workflow map between steps where real costs are incurred but are not reflected in the workflow. For example, there might be storage costs for in-process materials between steps. The storage of material is not a work item that is modeled in the workflow, so a new idea has to be added to the workflow for modeling costs outside of the work directly performed. The result is a unified workflow and financial cost model 16, which may reflect a plurality of workflows and financial models.

In step 2, the unified workflow model and financial cost model 16 has been deployed to a functional application and is executed by a workflow execution module 18. Each execution accumulates a workflow audit trail as well as detailed cost information. This information, consisting of workflow audit data 20 and cost data 22, can be routed simultaneously to two types of monitoring/controlling tasks, which are usually performed by different groups in the enterprise or company. In particular, in step 3, the workflow audit data is used in workflow monitoring and controlling applications 24 and cost data is also fed to financial monitoring and controlling applications 26. First, the workflow tools are used to evaluate the performance of the workflow, to see if any adjustments are required or if the work is proceeding optimally. In one embodiment, these tools present statistics such as number of executions, number of times each step is performed, step durations, delays, and so on, as well as summary data gathered in the workflow (data items used for decision-making in the workflow).

Also, in some embodiments in step 3, the workflow monitoring and controlling applications can present not just number of executions, but also real cost data. This would allow the business process owner to make evaluations and adjust the workflow based on the real cost of the work. For example, a business process (BP) owner might see that a certain step is performed 2× more frequently than another, and take action to reduce the number of times the more frequent step is executed. However, if the BP owner saw cost information, it might be revealed that the cost of the first step is only 0.4× the cost of the second, per execution, and thus the second step actually costs 25% more. Cost data presented in the workflow monitoring tool makes analysis, simulation, and optimization of the workflow far more relevant to the company.

Additionally, if the unified workflow and financial model 16 includes resource behavior such as the ability of the company to usefully absorb surpluses, then the simulation and analysis tools will be able to provide better information about the possible impact of changes. For example, a proposed change to the workflow might reduce the need for a particular resource, but if the surplus resource cannot be utilized productively elsewhere or efficiently reduced, then there is no actual financial benefit to the change. In another example, a proposed change to a workflow might require slightly more of a particular resource. If that resource is already utilized at capacity, then the change cannot be implemented, or must be implemented with a higher cost (outsourcing, or the cost of ramping up that resource).

As shown in block 28 and in step 4, when analysis of workflows may result in changes 28 to that workflow that rearrange the use of existing resources, the financial model that is connected to the workflow can be adjusted automatically. That is, those changes 24 may simultaneously update the unified workflow and financial model 16, so cost data continues to flow uninterrupted and with high quality. This allows the sometimes frequent changes to a workflow in production to continuously reflect current cost data to the monitoring and controlling tools.

In this embodiment, there is a feedback loop of cost distribution. This allows the financial group in the company to monitor the cost outputs of the workflow systems and make global changes to the distribution of costs. The idea is that there are a great number of different workflows operating in the company, and each one contributes costs and consumes resources. In this embodiment, the system 10 should have a facility for rolling up and distributing down the various costs and resource constraints. From a global financial perspective, a model of costs, activities, and distributions can be built. This global financial model 11 can be used in the development of the individual workflow/financial models. The output of each workflow is a set of costs that can be rolled up and then compared with the global model 11. A financial analyst can review the data and make changes to the global financial model. This would then automatically be distributed into each workflow, and so on.

In more detail, in step 3, the cost data generated in the workflow are provided to financial monitoring and controlling tools 26. These are typically consumed by the financial side of the company, and used to monitor the business as a whole. As shown in step 5, financial analysis of the company may result in changes to multiple workflows and to business process, shown as block 30, as well as changes to the global financial model 11. Both types of changes are instantly reflected in the unified workflow and financial model 16 that is already deployed. A benefit of this embodiment is that data is current and cost modeling is continuously updated based on changes to workflow or to business processes, block 30, at the business unit or departmental level.

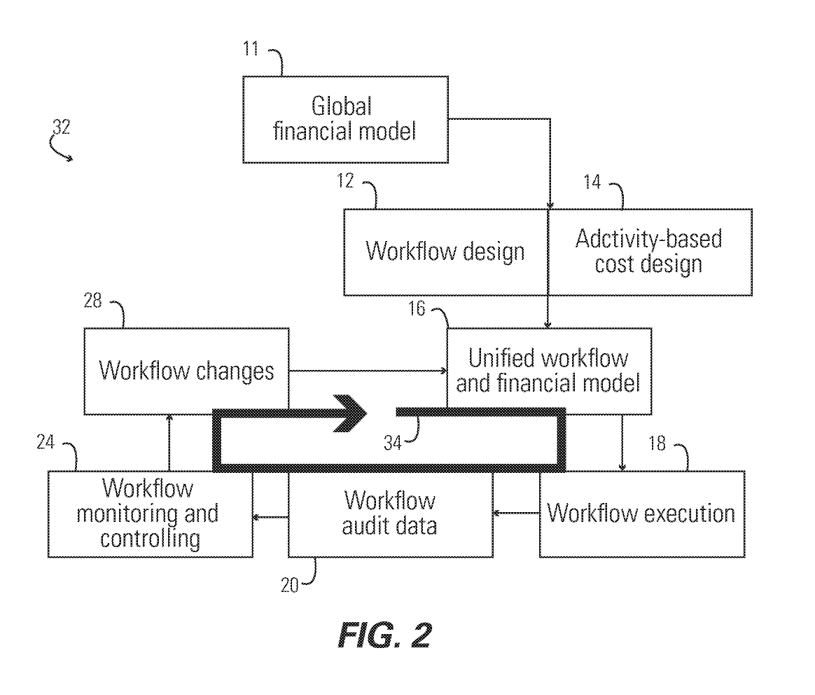

Referring now to FIG. 2, another conceptual block diagram of a system 32 illustrates business process analysis in accordance with an embodiment of the invention. A feedback loop 34 illustrates the execution of many instances of workflows that are deployed. In this loop 34, the workflow runs, and a business process owner periodically monitors the workflow, analyzes results of many executions, perhaps performs some simulations, and then makes small changes to the workflow. This is a fairly rapid loop and many workflows are tweaked frequently in this way. Cost data is a valuable addition to the optimization of work at the individual business process level.

In particular, the workflow monitoring and controlling applications 24 are used to analyze results and propose changes to the workflow, shown in block 28. These workflow changes 28 are implemented, tested and employed. The unified workflow and financial model 16 is updated in tandem. One advantage of this feature is that cost data is continuously accumulated and the financial model remains valid without deep analysis of each change to the business process.

The invention can take the form of an entirely hardware embodiment, an entirely software embodiment or an embodiment containing both hardware and software elements. In a preferred embodiment, the invention is implemented in software, which includes but is not limited to firmware, resident software and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, or an optical disk. Current examples of optical disks include compact disk-read-only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

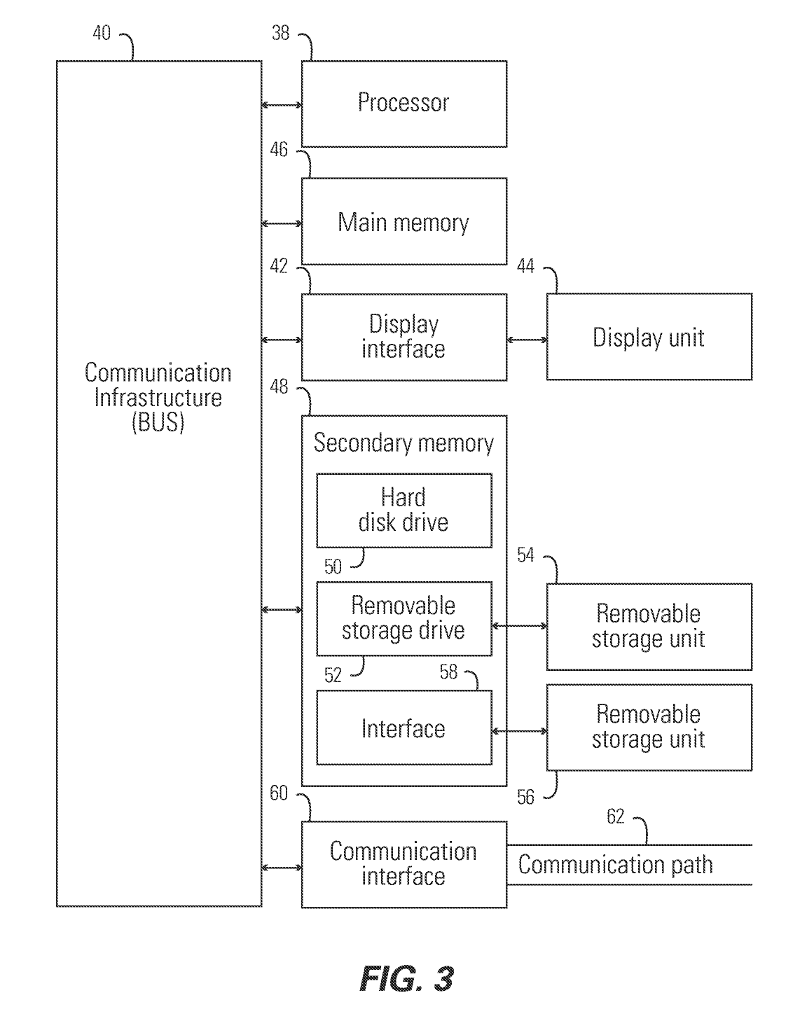

FIG. 3 is a high level block diagram showing an information processing system useful for implementing one embodiment of the present invention. The computer system includes one or more processors, such as processor 38. The processor 38 is connected to a communication infrastructure 40 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 42 that forwards graphics, text, and other data from the communication infrastructure 40 (or from a frame buffer not shown) for display on a display unit 44. The computer system also includes a main memory 46, preferably random access memory (RAM), and may also include a secondary memory 48. The secondary memory 48 may include, for example, a hard disk drive 50 and/or a removable storage drive 52, representing, for example, a floppy disk drive, a magnetic tape drive or an optical disk drive. The removable storage drive 52 reads from and/or writes to a removable storage unit 54 in a manner well known to those having ordinary skill in the art. Removable storage unit 54, represents, for example, a floppy disk, a compact disc, magnetic tape, optical disk, etc. which is read by and written to by removable storage drive 52. As will be appreciated, the removable storage unit 54 includes a computer readable medium having stored therein computer software and/or data.

In alternative embodiments, the secondary memory 48 may include other similar means for allowing computer programs or other instructions to be loaded into the computer system. Such means may include, for example, a removable storage unit 56 and an interface 58. Examples of such may include a program cartridge and cartridge interface (such as that found in video game devices), a removable memory chip (such as an EPROM, or PROM) and associated socket, and other removable storage units 56 and interfaces 58 which allow software and data to be transferred from the removable storage unit 56 to the computer system.

The computer system may also include a communications interface 60. Communications interface 60 allows software and data to be transferred between the computer system and external devices. Examples of communications interface 60 may include a modem, a network interface (such as an Ethernet card), a communications port, or a PCMCIA slot and card, etc. Software and data transferred via communications interface 60 are in the form of signals which may be, for example, electronic, electromagnetic, optical, or other signals capable of being received by communications interface 60. These signals are provided to communications interface 60 via a communications path (i.e., channel) 62. This channel 62 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 46 and secondary memory 48, removable storage drive 52 and a hard disk installed in hard disk drive 50.

Computer programs (also called computer control logic) are stored in main memory 46 and/or secondary memory 48. Computer programs may also be received via communications interface 60. Such computer programs, when executed, enable the computer system to perform the features of the present invention as discussed herein. In particular, the computer programs, when executed, enable the processor 38 to perform the features of the computer system. Accordingly, such computer programs represent controllers of the computer system.

From the above description, it can be seen that the present invention provides a system, computer program product, and method for integrating financial models into workflow software to enable Activity Based Costing (ABC). By introducing financial tools into a Business Process Management (BPM) system, the modeling of the workflow also models the cost drivers of the system.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

While the preferred embodiments of the present invention have been described in detail, it will be understood that modifications and adaptations to the embodiments shown may occur to one of ordinary skill in the art without departing from the scope of the present invention as set forth in the following claims. Thus, the scope of this invention is to be construed according to the appended claims and not limited by the specific details disclosed in the exemplary embodiments.

We claim:

1. A method for analyzing a workflow comprising:
designing a workflow;
designing activity-based cost distributions;
generating a unified workflow and financial model using said workflow and said activity-based cost distributions;
executing said unified workflow and financial model to generate workflow and cost data;
processing said workflow and cost data in a workflow monitoring and controlling application; and
processing said cost data in a financial monitoring and controlling application.

2. The method of claim 1 further comprising:
building and maintaining a global cost model; and
distributing said activity-based cost distributions over a plurality of said workflows.

3. The method of claim 2 further comprising modifying said global cost model based on said distributed activity-based cost distributions over a plurality of said workflows.

4. The method of claim 1 wherein said designing activity-based cost distributions further comprises assigning costs to work steps.

5. The method of claim 4 wherein said assigning costs further comprises assigning costs based on at least one of the following: fixed cost, data in said workflow and workflow durations.

6. The method of claim 1 wherein said processing said workflow and cost data in a workflow monitoring and controlling application further comprises evaluating the performance of workflow.

7. The method of claim 6 wherein said evaluating the performance of workflow further comprises evaluating at least one of the following: number of executions, number of times workflow steps are performed, workflow step durations, workflow step delays and summary data.

8. The method of claim 1 wherein said processing said workflow and cost data in a workflow monitoring and controlling application further comprises presenting real cost data.

9. The method of claim 8 further comprising using said real cost data to adjust workflow.

10. The method of claim 1 further comprising automatically adjusting said unified workflow and financial model when changes are made to said workflow that rearrange the use of existing resources.

11. The method of claim 1 further comprising generating a feedback loop of cost distribution.

12. A method of integrating a financial model into a workflow model comprising:
using a single tool for designing a workflow and for designing activity-based cost distributions;
using said workflow and said activity-based cost distributions to generate a unified workflow and financial model;
using said unified workflow and financial model to generate workflow and cost data; and
processing said workflow and cost data in a workflow monitoring and controlling application.

13. The method of claim 12 further comprising processing said cost data in a financial monitoring and controlling application.

14. The method of claim 12 further comprising initiating business process changes and automatically adjusting said unified workflow and financial model in response to said business process changes.

15. A workflow modeling system comprising:
workflow modeling tool including a workflow design tool and an activity-based cost design tool;
a unified workflow and financial model generated by said workflow modeling tool;
a workflow execution module executing said unified workflow and financial model;
workflow monitoring and controlling application receiving workflow and cost data from said workflow execution module; and
financial monitoring and controlling application receiving cost data from said workflow execution module.

16. The workflow modeling system of claim 15 further comprising a workflow change module for communicating workflow changes to said unified workflow and financial model, wherein said unified workflow and financial model is automatically modified in response to said workflow changes.

17. The workflow modeling system of claim 15 further comprising a business process change module for communicating business process changes to said workflow modeling tool, wherein said unified workflow and financial model is automatically modified in response to said workflow changes.

18. A computer program product comprising a computer usable medium having a computer readable program, wherein said computer readable program when executed on a computer causes said computer to:
design a workflow;
design activity-based cost distributions;
generate a unified workflow and financial model using said workflow and said activity-based cost distributions;
execute said unified workflow and financial model to generate workflow and cost data;
process said workflow and cost data in a workflow monitoring and controlling application; and
process said cost data in a financial monitoring and controlling application.

19. The computer program product of claim 18 wherein said computer readable program further causes said computer to automatically adjust said unified workflow and financial model when changes are made to said workflow that rearrange the use of existing resources.

20. The computer program product of claim 18 wherein said computer readable program further causes said computer to:
generate a first feedback loop that is local to each said workflow; and
generate a second feedback loop that covers multiple workflows and business processes.
